(19) United States
(12) Patent Application Publication
(10) Pub. No.: US 2020/0370665 A1
(43) Pub. Date: Nov. 26, 2020

(54) DEVICE AND METHOD FOR WASHING A SURFACE OF A MOTOR VEHICLE PART AND FLUID CONTROL VALVE FOR SUCH DEVICE

(71) Applicant: Fico Transpar, S.A., Barcelona (ES)

(72) Inventors: Viktor Maurer Géza, Viladecavalls (ES); Olallo Alcaide Hernández, Viladecavalls (ES)

(21) Appl. No.: 16/879,396

(22) Filed: May 20, 2020

(30) Foreign Application Priority Data
May 21, 2019 (EP) 19382408.3

(51) Int. Cl. F16K 11/02; F16K 17/04; B60S 1/56

(52) U.S. Cl. CPC F16K 11/022; B60S 1/56; F16K 17/04

(57) ABSTRACT

The device comprises a first fluid pump for supplying first fluid from a first fluid source to the fluid control valve, a second fluid pump for supplying a flow of a second fluid from a second fluid source to the fluid control valve, and a pressure container for containing pressurized second fluid, the fluid control valve comprising a first fluid channel, a separate second fluid channel, a valve member for closing the second fluid channel when no first fluid flows through the fluid control valve or opening the second fluid channel when no second fluid flows through the fluid control valve or when second fluid flows with a low pressure, and a spring for biasing the valve member for closing the fluid control channel.

### CROSS-REFERENCE TO RELATED APPLICATIONS

This application claims the benefit of European Application Serial No. 19382408.3 filed May 21, 2019, the disclosure of which is incorporated herein by reference in its entirety.

### TECHNICAL FIELD

The present disclosure refers to a surface washing device, and more particularly, to an automotive surface washing device including a fluid control valve, and a method of operation.

### BACKGROUND

Cleaning systems that eject two different fluids, such as for example liquid and air, onto a surface of a motor vehicle part, such as a camera lens, for cleaning the part and removing water droplets attached thereon are known in the art.

Document EP3105089, for example, discloses an air and liquid cleaning system for ejecting a cleaning liquid and air onto a vehicle vision device. The cleaning system comprises at least one liquid nozzle, at least one cleaning liquid pump fluidly connected to a fluid supply conduit and to a cleaning liquid source, at least one air nozzle, and at least one air jet generating means fluidly connected to the at least one air nozzle. The air jet generating means are hydraulically connected to the fluid supply conduit and the air jet generating means are operable by the fluid pressure from the cleaning fluid pump such that during a first operation time interval of the cleaning system only cleaning liquid is propelled onto the vehicle vision device or onto the vehicle sensor and that during a second operation time interval of the cleaning system only an air jet burst after the opening of a solenoid valve is propelled onto the vehicle vision device or onto the vehicle sensor.

Document EP3239006 discloses a foreign matter removal device comprising a cylinder in which air is introduced; a piston movably supported to the cylinder and configured to deliver air introduced into the cylinder as high-pressure air; a nozzle for injecting high-pressure air delivered by the piston towards an object to be washed; a spring for urging the piston, and a mechanism for moving the piston to a predetermined position by applying a force to the piston. The cylinder is provided with a piston support part for movably supporting the piston and a coupling protrusion having a delivery path configured to deliver high-pressure air to the nozzle.

Known prior art devices intended to eject liquid and air onto a surface to be washed involve the use of expensive valves, as solenoid valves, or other complex control elements which result in undesirable high costs and complexity.

### SUMMARY

The present disclosure refers to a device for washing a surface of a motor vehicle part, a fluid control valve for such device, and to a method for washing a surface of a motor vehicle part.

Although the present device, fluid control valve, and method are disclosed herein for washing a surface of a motor vehicle part, the present device, fluid control valve, and method are also suitable for removing water drops or a water layer from a surface of a motor vehicle part, such as for example a camera lens or any other parts. Water drops or a water layer may result from water remaining on the surface, e.g. after a washing operation, due to dew, water drops coming from the road or other car body parts during rainy weather, etc. This may be a problem in different situations as water drops may deteriorate visibility especially in extreme lighting conditions like night driving with headlight reflections. Large water drops, for example on a camera lens may hide great areas that are important for visibility. In vehicle cameras connected with shape-object recognition systems, efficiency of recognition may be greatly decreased due to blurriness caused by water on the camera lens.

The present fluid control valve comprises at least one first fluid channel and at least one second fluid channel. The second fluid channel is separate from the first fluid channel. Fluid channels refers herein to ducts, pipes, passageways, and the like through which a fluid, such as air or water, may be allowed to flow. The present fluid control valve may be configured as for example a four-way valve.

The present fluid control valve also comprises a valve member. The valve member may be configured, for example, as a piston or membrane mechanism, suitably configured to be driven at least into two different positions:

a closed position where the second fluid channel of the fluid control valve is closed when first fluid flows through the first fluid channel with a first fluid pressure higher than a predetermined valve element pressure plus a second fluid channel pressure, or

an open position where the second fluid channel of the fluid control valve is open when no first fluid flows through the first fluid channel or when first fluid flows with a first fluid pressure lower than the predetermined valve member pressure plus the second fluid channel pressure.

In one example, the predetermined valve element pressure may be lower than 2 bar, and depending on the needs, preferably lower than 0.5 bar. In general, it may be preferred that the valve member is configured to be driven into an open position opening the second fluid channel when the first fluid pressure is lower than 0.3 bar when there is no second fluid flowing through the second fluid channel.

As used herein, predetermined valve element pressure refers to a pressure value required for closing the second fluid channel by the valve element if no pressure were acting in the second fluid channel. Therefore, the first fluid pressure should be greater than that required by the valve element so that it is changed in position to close the second fluid channel.

Biasing means, such as a compression spring or the like, may be provided for biasing the valve member for closing the first fluid channel. The amount of the above mentioned first fluid pressure is preferably greater than that of a force applied by the biasing means for biasing the valve member plus the second fluid channel pressure so as to open the first fluid channel.

A device for washing a surface of a motor vehicle part is also disclosed herein. The present washing device comprises first and second fluid pumps. The first fluid pump is intended for supplying first fluid from a first fluid source to a fluid control valve as described above. The second fluid pump is intended for supplying a flow of a second fluid from a second fluid source to the fluid control valve.

At least one first fluid outlet and at least one second fluid outlet are provided. The first fluid outlet is intended for supplying first fluid from the fluid control valve to the motor vehicle part. The second fluid outlet is intended for supplying second fluid from the fluid control valve to the motor vehicle part.

With the above described configuration, in use, the first and second fluid pumps may be operated such that first fluid is allowed to flow through the fluid control valve to the surface of the motor vehicle part while second fluid is prevented from flowing through the fluid control valve. At this point, the second fluid is being pressurized by the second fluid pump, for example inside a pressure container. The first fluid pump is then shut down such that no first fluid flows through the fluid control valve while second fluid is being pressurized by the second fluid pump as stated above. A second fluid burst is then supplied to the surface of the motor vehicle part which may occur when no first fluid flows through the fluid control valve as second fluid has been pressurized enough in the pressure container.

As stated above, a pressure container may be provided for containing second fluid to be pressurized by the second fluid pump so as to cause the above mentioned burst of second fluid to be ejected to the surface of the motor vehicle part. The pressure container, when provided, is closed by the fluid control valve. Such pressure container may be a dedicated container, or may be defined by an interior volume of a second fluid circuit by for example at least one pipe.

In one example, at least one of the first and second fluid outlets may comprise a nozzle that is configured to direct a fluid to a surface of a motor vehicle part as stated above, such as a fluid burst in the case of the second fluid.

A control unit, such as a vehicle electronic control unit, may be provided. The control unit may be configured for controlling the second fluid pump to continue supplying second fluid to the surface of the motor vehicle part after the burst of second fluid. Then, a continuous flow of second fluid is supplied to the surface of the motor vehicle part during a predetermined period of time. The control unit may be also configured operating the first fluid pump and/or the second fluid pump at least during operation of the water pump.

The first fluid pump may be configured for supplying first fluid with a pressure higher or equal than the first fluid pressure. The second fluid pump may be configured for supplying second fluid with a pressure higher than or equal to the second channel pressure when the second fluid flows through the second channel, with the first fluid pressure being higher than the second fluid channel pressure plus the valve member pressure.

A first fluid tank may be further provided for containing first fluid to be pumped to the fluid control valve.

A method for washing a surface of a motor vehicle part using the above described device is also provided. The present washing method comprises operating the first fluid pump for causing a first fluid to flow through the first fluid channel of the fluid control valve with a first fluid pressure and out towards a surface of a motor vehicle part, closing the second fluid channel of the fluid control valve by the flow of first fluid through the first fluid channel of the fluid control valve, operating the second fluid pump for causing a second fluid to flow through the second fluid channel of the fluid control valve with a second fluid pressure into a pressure container causing the second fluid to be pressurized therein, shutting down the first fluid pump, preventing the first fluid from flowing through the first fluid channel of the fluid control valve, allowing the second fluid to flow through the second fluid channel of the fluid control valve resulting in a burst of the second fluid being supplied towards the surface of the motor vehicle part. Second fluid pump may be finally shut down into a non-operating state to complete washing process.

Both the first and second fluid pumps may be operated at the same time for example in a transient state between a state when first and second fluid pumps are not operated and a state when first and second fluid pumps are operated such as when the surface of a motor vehicle part is washed while the second fluid is being pressurized with the second fluid channel closed when the first fluid is flowing through the first channel. Since the second fluid is pressurized when no second fluid is required, pump operational time is optimized. The second fluid pump may be operated before the first fluid pump, or both the first and second fluid pumps may be operated simultaneously, or the second fluid pump may be operated after the first pump. In any case, it is important that both the first and second fluid pumps are operated simultaneously at a given time.

In one preferred example, the first fluid is a liquid such as cleaning liquid or water and the second fluid is a gas such as air. Other fluids are of course possible. The fluid control valve would be in this preferred example a liquid-air valve wherein the first fluid channel is a liquid channel and the second fluid channel is an air channel. Also in this preferred example the first fluid pump would be a liquid pump for supplying liquid from a liquid source to the fluid control valve and the second fluid pump would be an air pump for supplying a flow of air, preferably a pressurized flow of air, from an air source to the fluid control valve. The air source may be from the environment, or may be an air tank, or other form, and it may be treated, pressurized, or other.

More in detail, and in view of the above preferred example, according to the present method for washing a surface of a motor vehicle part using the above described device, the following specific phases may be performed.

A washing phase may be performed where air pressure is built-up in the above mentioned pressure container as both the liquid pump and the air pump are in operation. The surface of the motor vehicle part, for example, a camera lens, is then washed by the liquid that is being supplied through liquid nozzle. Air flow through the air channel is blocked by liquid pressure in the liquid-air valve. Air pressure continues building-up in the pressure container during a pre-defined washing time period.

A fluid burst-phase may be performed where the air pump is still in operation and liquid pressure in the liquid-air valve drops and the air channel in the liquid-air valve opens such that pressurized air is suddenly released causing an air burst to be supplied to the surface of the motor vehicle part.

A drying phase may be performed where the air pump is still in operation and during a drying time period during which a continuous air flow is delivered to the surface of the motor vehicle part so that remaining humidity is removed therefrom.

A final phase may be performed where after washing and drying phases have been completed. The air pump is shut down after washing and drying time periods have been elapsed.

The present device, fluid control valve, and method for washing a surface of a motor vehicle part all involve a number of significant advantages. In the fluid burst-phase, liquid layer in the surface of the motor vehicle part is broken or displaced, and in the drying phase small drops already present in the surface are dried or removed by the continuous air flow. As a result, a more efficient cleaning of the surface of the motor vehicle part is provided, causing opening/rupture of a liquid layer on the surface while removing remaining humidity and water droplets.

Time required to remove liquids from a surface is highly reduced. Air pressure is built up during washing cycle as a result of which time is not wasted. Air bursts shorten the drying phase and they are released immediately at the end of the washing phase. This greatly reduces drying/water removal times so the interval during which the surface to be washed is obstructed, for example a camera lens, is greatly reduced. This is of high importance specially when the part is a camera lens, where image may be distorted by water resulting in driver's vision or camera detection algorithm to be obstructed.

The present valve, device and method are cost effective as compared to prior art solutions using expensive solenoid valves. The use of the above described fluid control valve also allows the device to work automatically without requiring controllers.

Furthermore, supplying air bursts and then continuous air flow has been found to be advantageous in drying/water removal of surfaces. The present device provides immediate cleaning of a surface and when remaining liquid or small drops are present thereon, they are efficiently and quickly removed by continuous air flow since the liquid layer and drops are already in movement by the initial air burst. Still at high altitudes, i.e. above sea level, where air density is lower, water removal/drying is performed very efficiently with the present device, fluid control valve, and method by combining water flow, air burst, and continuous air flow.

Finally, a very compact fluid control valve can be produced and thus a very compact device, which can be operated with low noise, low power consumption, and low heat generation by water pump with no cooling operation being required to avoid overheating.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a general perspective view of a non-limiting, exemplary, embodiment of a device for washing a surface of a motor vehicle part;

FIG. 2 is a general isometric view of a fluid control valve of the device shown in FIG. 1;

FIG. 3 is a sectional view of the fluid control valve in FIG. 2, shown in a default state; and

FIG. 4 is a sectional view of the fluid control valve in FIG. 2, shown in an operating state.

### DETAILED DESCRIPTION

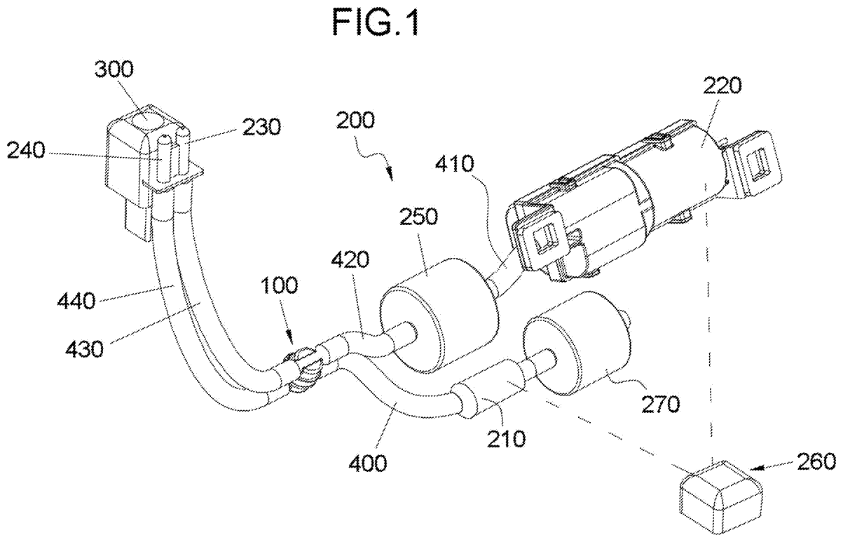

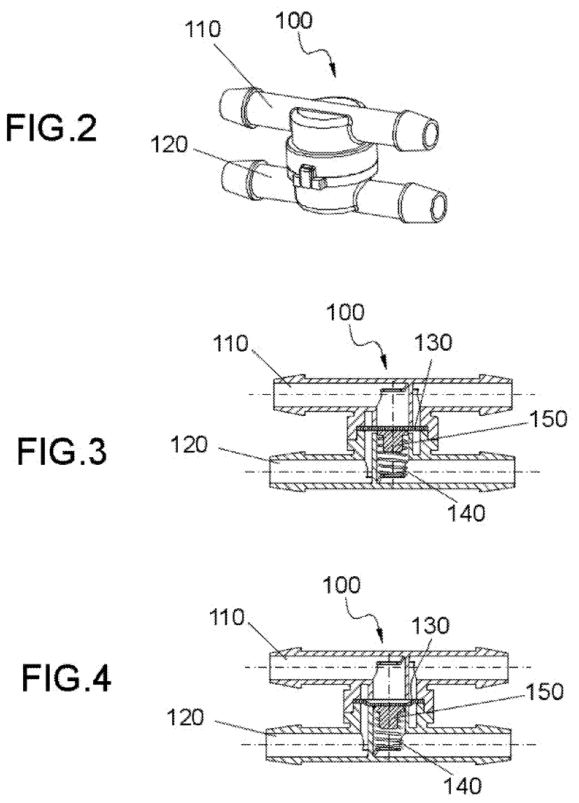

According to the drawings in FIGS. 1 through 4, one example of a device 200 for washing a surface of a motor vehicle part 300 is shown. In the example shown, the motor vehicle part is a camera lens 300.

Referring to FIG. 1, a first fluid pump 210 is provided for supplying first fluid, water hereinafter, from a water source 270 to a fluid control valve, air-water control valve 100 hereinafter, through a first pipe 400.

A second fluid pump 220 is also provided for supplying second fluid, air hereinafter, from an air source, not shown, through a second pipe 410 to a pressure container 250, which will be described further below, and hence to the air-water control valve 100, through a third pipe 420.

Unless otherwise indicated, pressure refers to pressure values in the fluid control valve. Supply pressure values in fluid pump are usually higher than, or equal to, those in fluid control valve.

A first fluid nozzle 240 is provided for supplying water from the air-water control valve 100 to the motor vehicle part 300 through fourth pipe 440. A second fluid nozzle 230 is also provided for supplying air from the air-water control valve 100 to the motor vehicle part 300 through fifth pipe 430. Fluid nozzles 240, 230 may be made integral with the vehicle part.

Referring to FIGS. 3 and 4 of the drawings, the air-water control valve 100 is configured as a four-way valve comprising a water channel 110 and an air channel 120 that is separate from the water channel 110, that is, both channels 110, 120 are configured as independent fluid channels. The water channel 110 is formed in an air-water control valve body and it may define an area referred to as controller side. The air channel 120 is also formed in the air-water control valve body and it may define an area referred to as supply side.

The air-water control valve 100 is fluidly connected to first and third pipes 400, 420, on one side, and to the above mentioned fourth and fifth pipes 440, 430, on the other side. The fourth pipe 440 leads to water nozzle 240 while the fifth pipe 430 leads to air nozzle 230. The air-water control valve 100 also comprises a valve member 130. The valve member in the example shown is configured as a membrane 130. The membrane 130 may be made for example of rubber or any other similar material capable for opening or closing the water channel 110 and the air channel 120 when deformed (i.e., when bent), depending on fluid flowing through the air-water control valve 100. Membrane 130 is configured such that its deformation or bending under pressure built-up on both sides of the air channel 120 causes the air circuit to close in only few milliseconds, with air escape being negligible if any. The membrane 130 is made so as to prevent leakage and water backflow.

The air-water control valve 100 is thus operable at least into two different positions of the membrane 130. The air-water control valve 100 is operable into a closed position of the membrane 130 where the air channel 120 is closed when water is flowing through the water channel 110 with a water pressure PA higher than a predetermined valve element pressure or cracking pressure PV plus a second fluid channel pressure PA′. The air-water control valve 100 is also operable into an open position of the membrane 130 where the water channel 110 is open when no water flows through the water channel 110 or when water flows with a water pressure PA lower than the cracking pressure PV plus the second fluid channel pressure PA′.

A compression spring 140 is fitted in the air-water control valve 100 for biasing the membrane 130 through a pusher 150 upwards in FIGS. 3 through 4 so as to close the water channel 110 of the air-water control valve 100. While water pressure PA is lower than the cracking pressure PV plus second fluid channel pressure PA′ water flow is stopped by membrane 130 and spring 140 acting as a check valve.

In this example, the cracking pressure PV in the air-water control valve 100 is lower than 2 bar, preferably 0.5 bar. In general, the water pressure may be of the order of 10 bar or less, preferably, 6 bar or less. Air pressure PA′ in the air-water control valve 100 may be of the order of 4 bar or less, preferably, 0.1-2.5 bar. Other ranges of pressure values are still possible.

FIG. 3 shows the air-water control valve 100 in a non-operating state where the water channel 110 is closed and the air channel 120 is open. FIG. 4 shows the air-water control valve 100 in an operating state where the water channel 110 is open and the air channel 120 is closed as a result of the membrane 130 being deformed or bent by water flow.

As shown in FIG. 1 of the drawings, a pressure container 250 is provided for containing air to be pressurized by the air pump 220. In the example shown, a volume of the pressure container 250 is within a range of ten to fifty milliliters (10-50 ml). A water tank 270 is provided for containing water to be pumped to the air-water control valve 100.

In use, the water pump 210 is operated for pumping water with a pressure higher than the above mentioned cracking pressure PV plus the second fluid channel pressure PA′ causing membrane 130 to be deformed, or bend (and/or even displaced), in a way that the water channel 110 of the air-water control valve 100 is open allowing water to flow therethrough and out towards a surface of a motor vehicle part 300 through water nozzle 240. Then, the air channel 120 of the air-water control valve 100 is closed by the flow of water through the water channel 110 of the air-water control valve 100. This causes air pump 220 to be operated pumping air to flow through the air channel 120 of the air-water control valve 100 with an air fluid pressure PA′ into the pressure container 250 and the second and third pipes 410, 420. This causes air to be pressurized inside the pressure container 250 and the pipes between the air pump 220 and the air-water control valve 100. The water pump 210 is then shut down while the air pump 220 is still in operation. As a result, water is prevented from flowing through the water channel 110 of the air-water control valve 100, and water pressure PA′ is lower than the cracking pressure PA plus the second fluid channel pressure PA′. Air is then allowed to flow through the air channel 120 of the air-water control valve 100 causing an air burst to be ejected towards the surface of the motor vehicle part 300 through air nozzle 230. Afterwards, a continuous air flow may be supplied by the air pump 220 that could still remain in operation during a given period of time after the water pump 210 is shut down. Water and air pumps 210, 220 are then shut down and membrane 130 returns back to an original, rest position. Air burst time may be within a range of 0.1 to 0.5 seconds

A control unit, in this case, a vehicle electronic control unit (ECU), 260 is provided. The ECU 260 may be configured for controlling the air pump 220 to continue supplying the above mentioned continuous flow of air to the surface of the motor vehicle part 300, during a predetermined period of time, such as for example ten seconds or less after the air burst has been supplied to the surface of the motor vehicle part 300. The ECU 260 may be also configured for operating the water pump 210 and/or the air pump 220 at least during operation of the water pump 210. Other control means such as timers may be used together with or as an alternative to the ECU 260.

In one embodiment, a washing cycle time when water pump 210 is in operation may be within a range of 0.3 seconds to 5.0 seconds.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation, or material, to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A fluid control valve comprising at least one first fluid channel and at least one second fluid channel separate from the first fluid channel, wherein it further comprises a valve member configured to be driven into a closed position closing the second fluid channel when first fluid flows through the first fluid channel with a first fluid pressure (PA) higher than a predetermined valve member pressure (PV) plus a second fluid channel pressure (PA′) or into an open position opening the second fluid channel when no first fluid flows through the first fluid channel or when first fluid flows with a first fluid pressure (PA) lower than the predetermined valve member pressure (PV) plus the second fluid channel pressure (PA′).

2. The fluid control valve of claim 1, wherein the predetermined valve member pressure (PV) is lower than 2 bar.

3. The fluid control valve of claim 1, wherein it comprises biasing means for biasing the valve member for closing the first fluid channel.

4. The fluid control valve of claim 3, wherein the amount of the valve member pressure (PV) is greater than or equal to a force applied by the biasing means for biasing the valve member for opening the first fluid channel.

5. The fluid control valve of claim 1, wherein the valve member is a piston or membrane mechanism.

6. The fluid control valve of claim 2, wherein it comprises biasing means for biasing the valve member for closing the first fluid channel.

7. The fluid control valve of claim 6, wherein the amount of the valve member pressure (PV) is greater than or equal to a force applied by the biasing means for biasing the valve member for opening the first fluid channel.

8. The fluid control valve of claim 7, wherein the valve member is a piston or membrane mechanism.

9. A device for washing a surface of a motor vehicle part, the device comprising:
a fluid control valve including at least one first fluid channel and at least one second fluid channel separate from the first fluid channel, a valve member configured to be driven into a closed position closing the second fluid channel when first fluid flows through the first fluid channel with a first fluid pressure (PA) higher than a predetermined valve member pressure (PV) plus a second fluid channel pressure (PA′) or into an open position opening the second fluid channel when no first fluid flows through the first fluid channel or when first fluid flows with a first fluid pressure (PA) lower than the predetermined valve member pressure (PV) plus the second fluid channel pressure (PA′);
a first fluid pump for supplying first fluid from a first fluid source to the fluid control valve;
a second fluid pump for supplying a flow of a second fluid from a second fluid source to the fluid control valve;
at least one first fluid outlet for supplying first fluid from the fluid control valve to the motor vehicle part; and
at least one second fluid outlet for supplying second fluid from the fluid control valve to the motor vehicle part.

10. The device of claim 9, wherein the first and second fluid pumps are adapted to operate such that first fluid is allowed to flow through the fluid control valve to the surface of the motor vehicle part while second fluid is prevented from flowing through the fluid control valve, with the second fluid pump in operation while the first fluid pump is shut down such that no first fluid flows through the fluid control valve (100) and a second fluid burst is supplied to the surface of the motor vehicle part.

11. The device of claim 9, further comprising: a pressure container adapted to contain a second fluid pressurized by the second fluid pump.

12. The device of any of claim 11, wherein the pressure container is one of a dedicated container, defined by an interior volume of a second fluid circuit, and defined by at least one pipe.

13. The device of claim 9, wherein at least one of the first and second fluid outlets includes a nozzle that is configured to direct a fluid burst to a surface of a motor vehicle part.

14. The device of claim 9, further comprising: a control unit configured such that after a second fluid burst has been supplied to the surface of the motor vehicle part, a continuous flow of second fluid is supplied to the surface of the motor vehicle part during a predetermined period of time.

15. The device of claim 14, wherein the control unit is configured for operating the second fluid pump at least during operation of the first fluid pump.

16. The device of claim 9, wherein the first fluid pump is configured for supplying first fluid with a pressure higher or equal than the first fluid pressure (PA) and the second fluid pump is configured for supplying second fluid with a second fluid pressure (PA′) higher or equal than the second channel pressure (PA′) when the second fluid flows through the second channel, the first fluid pressure (PA) being higher than the second fluid channel pressure (PA′) plus the valve member pressure (PV).

17. The device of claim 9, further comprising: a first fluid tank for containing first fluid to be pumped to the fluid control valve.

18. The device of claim 13, further comprising: a control unit configured such that after a second fluid burst has been supplied to the surface of the motor vehicle part, a continuous flow of second fluid is supplied to the surface of the motor vehicle part during a predetermined period of time.

19. The device of claim 14, wherein the first fluid pump is configured for supplying first fluid with a pressure higher or equal than the first fluid pressure (PA) and the second fluid pump is configured for supplying second fluid with a second fluid pressure (PA′) higher or equal than the second channel pressure (PA′) when the second fluid flows through the second channel, the first fluid pressure (PA) being higher than the second fluid channel pressure (PA′) plus the valve member pressure (PV).

20. A method for washing a surface of a motor vehicle part using the device of claim 7, wherein the method comprises:
operating the first fluid pump for causing a first fluid to flow through the first fluid channel of the fluid control valve with a first fluid pressure (PA) and out towards a surface of a motor vehicle part;
closing the second fluid channel of the fluid control valve by the flow of first fluid through the first fluid channel of the fluid control valve;
operating the second fluid pump for causing a second fluid to flow through the second fluid channel of the fluid control valve with a second fluid pressure (PA′) into a pressure container causing the second fluid to be pressurized therein;
shutting down the first fluid pump;
preventing the first fluid from flowing through the first fluid channel of the fluid control valve or reducing the first fluid pressure (PA) lower than the predetermined valve member pressure (PV) plus the second fluid channel pressure (PA′); and
allowing the second fluid to flow through the second fluid channel of the fluid control valve resulting in a burst of the second fluid being supplied towards the surface of the motor vehicle part.
